(19) United States
(12) Patent Application Publication
(10) Pub. No.: US 2019/0143640 A1
(43) Pub. Date: May 16, 2019

(54) ABSORBENT LAMINATE WITH BOND PATTERN AND METHODS OF MAKING AND USING THE SAME

(71) Applicant: Precision Fabrics Group, Inc., Greensboro, NC (US)

(72) Inventor: Rene Kapik, Greensboro, NC (US)

(21) Appl. No.: 16/184,395

(22) Filed: Nov. 8, 2018

Related U.S. Application Data
(60) Provisional application No. 62/584,385, filed on Nov. 10, 2017.

(51) Int. Cl. B32B 7/04; B32B 5/02; B32B 5/26; B32B 27/12; B32B 37/06

(52) U.S. Cl. CPC B32B 7/045; B32B 5/022; B32B 5/26; B32B 27/12; B32B 2307/7265; B32B 2250/24; B32B 2307/726; B32B 2250/03; B32B 37/065

(57) ABSTRACT

A multi-layered laminate is described along with methods of making and/or using the same. The laminate may be thermally or ultrasonically laminated and have a bond pattern including a plurality of bond points having an area of about 0.5 mm² to about 2.5 mm² (e.g., about 1 or 1.6 mm²) and at least a portion of the bond points in the plurality are separated from each other (in the horizontal and/or vertical direction) by 6 mm to about 25 mm. The laminate may be useful in medical applications.

### RELATED APPLICATION DATA

This application claims the benefit of U.S. Provisional Patent Application Ser. No. 62/584,385, filed Nov. 10, 2017, the disclosure of which is incorporated by reference herein in its entirety.

### FIELD

The present invention relates generally to laminated articles, such as absorbent nonwoven laminates, and to methods of making and/or using the same, including, for example, in medical applications such as medical drapes and/or fenestrations.

### BACKGROUND

Absorbent rate and capacity are important properties for nonwoven laminates, especially those designed for surgical applications. These absorption properties are important to retain bodily fluids to protect patients and surgical staff. Most attempts to improve the absorption properties of a nonwoven laminate incorporate materials and/or chemistries to enhance the hydrophilicity of the materials in the laminate which increases complexity of manufacture and cost of process and materials.

### SUMMARY OF EXAMPLE EMBODIMENTS

One aspect of the invention is directed to a multi-layered laminate comprising: a first nonwoven fabric; a second nonwoven fabric; and optionally a barrier material (e.g., a barrier film) and when the barrier material is present the second nonwoven fabric is between the first nonwoven fabric and the barrier material; wherein the second nonwoven fabric is bonded to the first nonwoven fabric and/or the barrier material with a bond pattern including a plurality of bond points with each bond point in the plurality having an area of about 0.5 mm² to about 2.5 mm² (e.g., about 1 or 1.6 mm²) and at least a portion of the bond points in the plurality are separated from an immediately adjacent bond point (e.g., in the horizontal and/or vertical direction) by 6 mm to about 25 mm.

Another aspect of the invention is directed to a method of manufacturing a multi-layered laminate, the method comprising: thermally or ultrasonically laminating together a first nonwoven fabric and a second nonwoven fabric and/or a barrier material and the second nonwoven fabric to provide a plurality of bond points, wherein bond points in the plurality of bond points have an area of about 0.5 mm² to about 2.5 mm² (e.g., about 1 or 1.6 mm²) and at least a portion of the bond points in the plurality of bond points are separated from each other (e.g., in the horizontal and/or vertical direction) by 6 mm to about 25 mm.

The foregoing and other aspects of the present invention will now be described in more detail including other embodiments described herein.

### BRIEF DESCRIPTION OF THE DRAWINGS

FIG. 1 illustrates an exemplary bond pattern for a multi-layered laminate according to embodiments of the invention.

FIG. 2 is a graph of absorption rate vs. distance between bond pins/bond pin shape according to embodiments of the invention.

FIG. 3 is a graph of absorption capacity vs. distance between bond pins/bond pin shape according to embodiments of the invention.

FIG. 4 is a graph of run-off vs. distance between bond pins/bond pin shape according to embodiments of the invention.

FIG. 5 is a graph of lamination bond strength vs. distance between bond pins according to embodiments of the invention.

### DETAILED DESCRIPTION

The present invention now will be described hereinafter with reference to the accompanying drawings and examples, in which embodiments of the invention are shown. This description is not intended to be a detailed catalog of all the different ways in which the invention may be implemented, or all the features that may be added to the instant invention. For example, features illustrated with respect to one embodiment may be incorporated into other embodiments, and features illustrated with respect to a particular embodiment may be deleted from that embodiment. Thus, the invention contemplates that in some embodiments of the invention, any feature or combination of features set forth herein can be excluded or omitted. In addition, numerous variations and additions to the various embodiments suggested herein will be apparent to those skilled in the art in light of the instant disclosure, which do not depart from the instant invention. Hence, the following descriptions are intended to illustrate some particular embodiments of the invention, and not to exhaustively specify all permutations, combinations and variations thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the invention herein is for the purpose of describing particular embodiments only and is not intended to be limiting of the invention. In case of a conflict in terminology, the present specification is controlling.

All publications, patent applications, patents and other references cited herein are incorporated by reference in their entireties for the teachings relevant to the sentence and/or paragraph in which the reference is presented.

Unless the context indicates otherwise, it is specifically intended that the various features of the invention described herein can be used in any combination. Moreover, the present invention also contemplates that in some embodiments of the invention, any feature or combination of features set forth herein can be excluded or omitted. To illustrate, if the specification states that a composition comprises components A, B and C, it is specifically intended that any of A, B or C, or a combination thereof, can be omitted and disclaimed singularly or in any combination.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

The term “about,” as used herein when referring to a measurable value such as a dosage or time period and the like refers to variations of ±20%, ±10%, ±5%, ±1%, ±0.5%, or even ±0.1% of the specified amount.

As used herein, phrases such as “between X and Y” and “between about X and Y” should be interpreted to include X and Y. As used herein, phrases such as “between about X and Y” mean “between about X and about Y” and phrases such as “from about X to Y” mean “from about X to about Y.”

The term “comprise,” “comprises” and “comprising” as used herein, specify the presence of the stated features, integers, steps, operations, elements, and/or components, but do not preclude the presence or addition of one or more other features, integers, steps, operations, elements, components, and/or groups thereof.

As used herein, the transitional phrase “consisting essentially of” means that the scope of a claim is to be interpreted to encompass the recited materials or steps recited in the claim and those that do not materially affect the basic and novel characteristic(s) of the claimed invention. Thus, the term “consisting essentially of” should not be interpreted to be equivalent to “comprising.”

As used herein, the term “increase” (and grammatical variations thereof) describe an elevation in the specific parameter of at least about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300%, 400%, 500% or more as compared to a control.

As used herein, the terms “reduce,” “diminish,” and “decrease” (and grammatical variations thereof), describe, for example, a decrease of at least about 5%, 10%, 15%, 20%, 25%, 35%, 50%, 75%, 80%, 85%, 90%, 95%, 97%, 98%, 99%, or 100% as compared to a control.

Like numbers refer to like elements throughout. In the figures, the thickness of certain lines, layers, components, elements or features may be exaggerated for clarity. The abbreviations “FIG. and “Fig.” for the word “Figure” can be used interchangeably in the text and figures.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s). It will be understood that the spatially relative terms are intended to encompass different orientations of an element or laminate in use or operation in addition to the orientation depicted in the figures. For example, if the laminate in the figures is inverted, elements described as “under” or “beneath” other elements or features would then be oriented “over” the other elements or features. Thus, the exemplary term “under” can encompass both an orientation of “over” and “under.” The laminate may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

Provided according to embodiments of the present invention is a multi-layered laminate including a bond pattern along with methods of making and using the same. In some embodiments, the bond pattern includes a plurality of bond points with each bond point in the plurality of bond points having an area in a range of about 0.5 mm² to about 2.5 mm² and at least a portion of the bond points in the plurality being separated from an immediately adjacent bond point (e.g., in the horizontal and/or vertical direction) by 6 mm to about 25 mm. In some embodiments, a bond point may have an area of about 0.5, 0.75, 1, 1.25, 1.5, 1.75, 2, 2.25, or 2.5 mm², and each bond point may have the substantially the same (e.g., within ±10%, 5%, or 1%) area or a different area. In some embodiments, the bond point has an area of about 1 or 1.6 mm², and each bond point in the plurality has substantially the same area (e.g., the area of each bond point is within ±10%). In some embodiments, a bond point in the plurality of bond points is separated from one or more immediately adjacent bond points by about 6, 7, 8, 9, 10, 11, 12, 13, 14, 15, 16, 17, 18, 19, 20, 21, 22, 23, 24, or 25 mm, optionally when measured from a bond point to an immediately adjacent bond point in the horizontal or vertical direction. The multi-layered laminate may comprise a first nonwoven fabric; a second nonwoven fabric; and optionally a barrier material (e.g., a barrier film). When the barrier material is present, the second nonwoven fabric is between the first nonwoven fabric and the barrier material. One or more (e.g., 1, 2, 3, 4, 5, 6, 7, or more) layers in a multi-layered laminate may be thermally and/or ultrasonically bonded together. In some embodiments, a first nonwoven fabric and a second nonwoven fabric are thermally and/or ultrasonically bonded together and/or a barrier material and the second nonwoven fabric are thermally and/or ultrasonically bonded together.

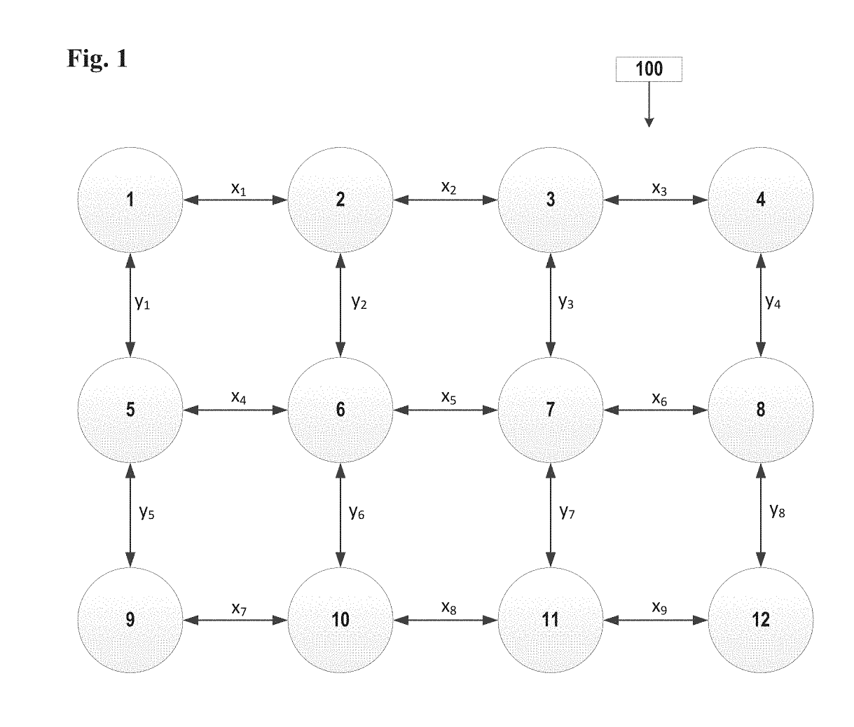

In some embodiments, all of the bond points in the multi-layered laminate are separated from an immediately adjacent bond point (e.g., in the horizontal and/or vertical direction) by 6 mm to about 15 mm, optionally by the same or a different amount. Referring now to FIG. 1, a multi-layered laminate may include a plurality of bond points 100 having respective bond points 1-12 being in the shape of a circle. Bond point 6 is immediately adjacent to bond point 5 and bond point 7 in the horizontal direction and to bond point 2 and bond point 10 in the vertical direction. Thus, in some embodiments, bond point 6 may be separated from bond points 2, 5, 7, and/or 10 by the same or a different amount. As shown in FIG. 1, in the horizontal direction (i.e., the x-dimension), the distance between bond point 5 and bond point 6 (i.e., x₄) is the same as the distance between bond point 6 and bond point 7 (i.e., x₅) and, in the vertical direction (i.e., the y-direction) the distance between bond point 2 and bond point 6 (i.e., y₂) and bond point 6 and bond point 10 (i.e., y₆) is the same. For example, each of bond points 1-12 in a plurality of bond points 100 may be separated from an immediately adjacent bond point in the horizontal and vertical direction by 6, 7, 8, 9, 10, 11, 12, 13, 14, 15, 16, 17, 18, 19, 20, 21, 22, 23, 24, or 25 mm.

The bond pattern in a multi-layered laminate of the present invention may be substantially uniform. In some embodiments, the bond pattern is an ordered array of bond points arranged in rows and columns, optionally with a bond point in each cell of the array, such as, e.g., shown in FIG. 1. Alternatively, in some embodiments, the bond points may be in a pattern, but a bond point may be present in every other cell. The bond points may be any suitable shape and/or dimension. In some embodiments, the bond points have a shape that is circular or diamond shaped. In some embodiments, the bond points have a diameter of about 1 mm. In some embodiments, the bond points have a pin height in a range of about 0.5 mm to about 2 mm. In some embodiments, the pin height may be about 0.5, 1, 1.5, or 2 mm.

The multi-layered laminate may have a bonded area of about 1% to about 20%. In some embodiments, the bonded area of the multi-layered laminate is about 1%, 2%, 3%, 4%, 5%, 6%, 7%, 8%, 9%, 10%, 11%, 12%, 13%, 14%, 15%, 16%, 17%, 18%, 19%, or 20%. In some embodiments, the bond pattern occupies an area of about 1% to about 20% of the surface area of the multi-layered laminate. In some embodiments, the multi-layered laminate may have about 10 to about 20 bonds per inch². In some embodiments, the multi-layered laminate has about 10, 11, 12, 13, 14, 15, 16, 17, 18, 19, or 20 bonds per inch².

Any suitable nonwoven fabric may be used in a multi-layered laminate of the present invention. In some embodiments, the nonwoven fabric in a multi-layered laminate of the present invention may comprise one or more fabric layers (e.g., 1, 2, 3, 4, 5, or more fabric layers). Example nonwoven fabrics include, but are not limited to, spun melt fabrics (e.g., spunbond-meltblown (SM) and spunbond-meltblown-spunbond (SMS)), stitchbonded fabrics, needlepunched fabrics, spunlaced fabrics, spunbonded fabrics, thermal bonded fabrics, powder bonded fabrics, chemical bonded fabrics, wet laid fabrics, resin bonded fabric, and/or air laid fabrics (e.g., air-laid pulp fabric). A nonwoven fabric that may be used to prepare and/or may be present in a multi-layered laminate of the present invention (e.g., optionally an outer nonwoven layer or the first nonwoven layer of the laminate) may be mechanically treated and/or have undergone any suitable mechanical treatment, including, but not limited to, calendaring, creping, embossing, and/or stretching. In some embodiments, a nonwoven fabric that may be used to prepare and/or present in a multi-layered laminate of the present invention (e.g., optionally an outer nonwoven fabric or the first nonwoven fabric of the laminate) may be and/or have been chemically treated for certain properties, such as, but not limited to, flame retardancy, oil, alcohol and/or water repellency, antistatic, antimicrobial, corrosion inhibition, color, opacity, dimensional stability, coefficient of friction, softness, drapability and/or the like.

Any suitable fiber may be used in a nonwoven fabric and/or fabric layer of the present invention in any suitable amount. Fibers may be natural fibers or synthetic fibers. Examples of fibers include, but are not limited to, bamboo fibers, cotton fibers, flax fibers, hemp fibers, jute fibers, polylactic acid fibers, silk fiberswool (e.g., alpaca, angora, cashmere, chiengora, guanaco, llama, mohair, pashmina, sheep and/or vicuna) fibers, acrylic fibers, glass fibers, lyocell fibers, melamine fibers, modacrylic fibers, polyacrylonitrile (e.g., oxidized polyacrylonitrile) fibers, polyamide (e.g., nylon and/or aramid) fibers, polyester fibers, polyimide fibers, polylactic acid fibers, polyolefin (e.g., polyethylene and/or polypropylene) fibers, polyvinyl acetate fibers, polyvinyl alcohol fibers, rayon fibers, viscose fibers, modified viscose (e.g., silica-modified viscose) fibers, zylon fibers, and/or bicomponent fibers (e.g., fibers comprising a copolymer and/or fibers comprising two or more polymers (e.g., polyester and polypropylene)). In some embodiments, at least one layer in a nonwoven fabric of the present invention comprises thermoplastic fibers. In some embodiments, a nonwoven fabric and/or fabric layer of the present invention comprises polypropylene fibers, polyester fibers, polyethylene fibers, nylon fibers, and/or bicomponent fibers therefrom. In some embodiments, a nonwoven fabric and/or fabric layer of the present invention (e.g., a nonwoven fabric layer) comprises polypropylene fibers.

In some embodiments, a multi-layered laminate of the present invention comprises a first nonwoven fabric and a second nonwoven fabric, one or both of which may comprise thermoplastic fibers. In some embodiments, the first nonwoven fabric comprises polypropylene fibers, polyethylene fibers, polylactic acid fibers, polyester fibers, wood pulp fibers, and/or blends and/or bicomponent fibers thereof. In some embodiments, the first nonwoven fabric comprises polypropylene fibers, optionally wherein the first nonwoven fabric is a spunbond polypropylene nonwoven fabric. In some embodiments, the second nonwoven fabric comprises polypropylene fibers, polyethylene fibers, polylactic acid fibers, polyester fibers, wood pulp fibers, rayon fibers, and/or blends and/or bicomponent fibers thereof.

The first nonwoven fabric of the multi-layered laminate may have a basis weight in a range of about 10 gsm to about 40 gsm, optionally about 15 gsm to about 35 gsm. In some embodiments, the first nonwoven fabric has a basis weight of about 10, 15, 20, 25, 30, 35, or 40 gsm. The second nonwoven fabric of the multi-layered laminate may have a basis weight in a range of about 15 gsm to about 100 gsm, optionally about 25 gsm to about 80 gsm. In some embodiments, the second nonwoven fabric has a basis weight of about 15, 20, 25, 30, 35, 40, 45, 50, 55, 60, 65, 70, 75, 80, 85, 90, 95, or 100 gsm.

The first and/or second nonwoven fabric may have a thickness in a range of about 1 mil to about 200 mils, such as, e.g., about 2 mils to about 10 mils, about 4 mils to about 8 mils, or about 10 mils to about 200 mils. In some embodiments, the first and/or second nonwoven fabric may have a thickness of about 1, 2, 3, 4, 5, 6, 7, 8, 9, 10, 11, 12, 13, 14, 15, 16, 17, 18, 19, 20, 30, 40, 50, 60, 70, 80, 90, 100, 110, 120, 130, 140, 150, 160, 170, 180, 190, or 200 mils.

In some embodiments, a multi-layered laminate of the present invention comprises a barrier material. The barrier material may be a film, such as, e.g., a thermoplastic film (e.g., a liquid impermeable thermoplastic film, which may be water-vapor permeable). The barrier material may comprise one or more barrier material layers (e.g., 1, 2, 3, 4, 5, or more fabric layers). In some embodiments, the barrier material is a single layer (e.g., a single film layer). In some embodiments, the barrier material comprises a film, such as, but not limited to, a homopolymer, microporous (e.g., pin-hole free microporous) and/or monolithic film such as, e.g., a polypropylene, polyethylene, polyester, polyvinyl chloride (PVC), polyvinyl alcohol (PVOH), ethylene vinyl alcohol (EVOH), polyvinylidene chloride, polyvinylidene fluoride, polyethylene terephthalate (PET), polybutylene terephthalate (PBT), PET/PBT blends, ethylene vinyl acetate, and/or polyurethanes films.

The barrier material may have a thickness in a range of about 0.0001 inches to about 0.04 inches, such as, e.g., about 0.0001 inches to about 0.02 inches, about 0.0004 inches to about 0.03 inches, or about 0.001 inches to about 0.03 inches. In some embodiments, the barrier material may have a thickness of about 0.0001, 0.0002, 0.0003, 0.0004, 0.0005, 0.0006, 0.0007, 0.0008, 0.0009, 0.001, 0.002, 0.003, 0.004, 0.005, 0.006, 0.007, 0.008, 0.009, 0.01, 0.02, 0.03, or 0.04 inches. In some embodiments, the barrier material may have a thickness in a range of about 0.5 mil to about 3 mil. In some embodiments, the barrier material may have a thickness of about 0.5, 1, 1.5, 2, 2.5, or 3 mil.

The barrier material may have a basis weight in a range of about 10 gsm to about 30 gsm, such as, e.g., about 10 gsm to about 20 gsm. In some embodiments, the basis weight of the barrier material may be about 10, 15, 20, 25, or 30 gsm.

A multi-layered laminate of the present invention may have a basis weight in a range of about 50 gsm to about 300 gsm, optionally about 60 gsm to about 120 gsm. In some embodiments, the multi-layered laminate has a basis weight of about 50, 55, 60, 65, 70, 75, 80, 85, 90, 95, 100, 105, 110, 115, 120, 125, 130, 135, 140, 145, 150, 175, 200, 225, 250, 275, or 300 gsm. The multi-layered laminate may have a thickness in a range of about 500 microns to about 2,000 microns. In some embodiments, the multi-layered laminate has thickness of about 500, 600, 700, 800, 900, 1000, 1100, 1200, 1300, 1400, 1500, 1600, 1700, 1800 1900, or 2000 microns.

In some embodiments, a multi-layered laminate of the present invention may comprise a first nonwoven fabric and a second nonwoven fabric, each of which may comprise one or more layers. In some embodiments, multi-layered laminate of the present invention may comprise a first nonwoven fabric, a second nonwoven fabric, and a barrier material, each of which may comprise one or more layers. One or more layers of a multi-layered laminate of the present invention may be thermally and/or ultrasonically bonded (e.g., attached). In some embodiments, all of the layers of the multi-layered laminate are thermally or ultrasonically bonded. In some embodiments, the first nonwoven fabric and the second nonwoven fabric may be thermally or ultrasonically bonded, and the barrier material (if present may be adhesively bonded to a surface of the second nonwoven fabric. In some embodiments, the second nonwoven fabric and the barrier material may be thermally or ultrasonically bonded and the first nonwoven fabric may be adhesively bonded to a surface of the second nonwoven fabric.

The first nonwoven fabric may provide one or more of the following: abrasion resistance, fluid acquisition, low lint and/or lint barrier to lint-prone interior (e.g., core) layer(s), and/or color (attribute—visual). In some embodiments, the first nonwoven fabric comprises and/or is a polypropylene spunbond, a polyethylene spunbond, a polypropylene/polyethylene bicomponent spunbond, a polylactic acid (PLA) spunbond, a polyester spunbond, or a wood pulp/polyester staple fiber or spunbond spunlace (chemically treated or untreated). In some embodiments, the first nonwoven fabric may have a basis weight of about 10 gsm to about 35 gsm.

The second nonwoven fabric may provide one or more of the following: absorbency rate, absorbent capacity, absorbent run-off, and/or bulk (attribute—comfort). In some embodiments, the second nonwoven fabric comprises and/or is a wood pulp/polypropylene or polypropylene blended or bicomponent spunbond spunlace, a wood pulp/polypropylene/rayon blended spunlace, a polyester/polypropylene or polyethylene or bicomponent through-air bonded, a polypropylene spunbond, a hydroentangled/hydrogen grouped polypropylene or bicomponent spunbond, a polypropylene meltblown, a polyester through-air bonded, or a polyester/polypropylene or polyethylene blended or bicomponent needlepunch. In some embodiments, the first nonwoven fabric may have a basis weight of about 25 gsm to about 100 gsm.

The barrier material may provide one or more of the following: a barrier to fluids when required and/or an adhesion surface (e.g., to base article/drape). In some embodiments, the barrier material comprises and/or is a polypropylene homopolymer or microporous film, a polyethylene homopolymer or microporous film, a blend of polypropylene or polyethylene (e.g., synthetic rubbers, etc.), or a polyester homopolymer or monolithic film. In some embodiments, the barrier material may have a thickness of about 0.5 mil to about 3 mil.

According to some embodiments of the present invention, the bond pattern of a multi-layered laminate of the present invention may maintain loft of the multi-layered laminate and may optimize surface geography, which may enhance fluid penetration and/or minimize its “run off” of the nonwoven laminate. In some embodiments, a multi-layered laminate of the present invention has a one or more improved properties (e.g., higher absorption capacity and/or faster absorption rate) compared to a laminated article not in accordance with the present invention (e.g., an article with the same materials and structure, but with a different bond pattern (e.g. a bond pattern not in accordance with the present invention)) and/or a laminated article with absorption enhancements incorporated.

In some embodiments, a multi-layered laminate of the present invention is a thermal lamination of thermoplastic nonwoven fiber using bond points of 1 mm² bonding area but the bond points separated from each other by at least 6 mm or 7 mm, which may enhance absorbent rate and/or absorbent capacity compared to a laminated article not in accordance with the present invention (e.g., an article comprising the same materials and structure, but with bond points are separated by 4 or 5 mm).

Current commercial approaches to improve absorption of a nonwoven fabric include: incorporation of hydrophilic fibers (i.e. cellulose) in the laminate, incorporation of hydrophilic materials (i.e. absorbent powders), incorporation of hydrophilic finishing chemistries (surfactants), increased surface area in the layers of the nonwoven (melt-blown component in nonwoven), and/or increased interstitial space in the nonwoven layers (greater loft). In some embodiments, a multi-layered laminate of the present invention may not utilize one or more of these approaches to improve absorption rate and/or absorption capacity. In some embodiments, the first nonwoven fabric and/or the second nonwoven fabric of the laminate of the present invention may comprise hydrophobic materials and/or hydrophilic materials (e.g., hydrophobic fibers and/or hydrophilic fibers). In some embodiments, the first nonwoven fabric and/or the second nonwoven fabric may be devoid of hydrophilic materials (e.g., hydrophilic fibers, compounds (e.g., surfactants), and/or powders). In some embodiments, the first and/or second nonwoven fabric does not incorporate and/or include materials and/or chemistries to enhance the hydrophilicity of the fabric.

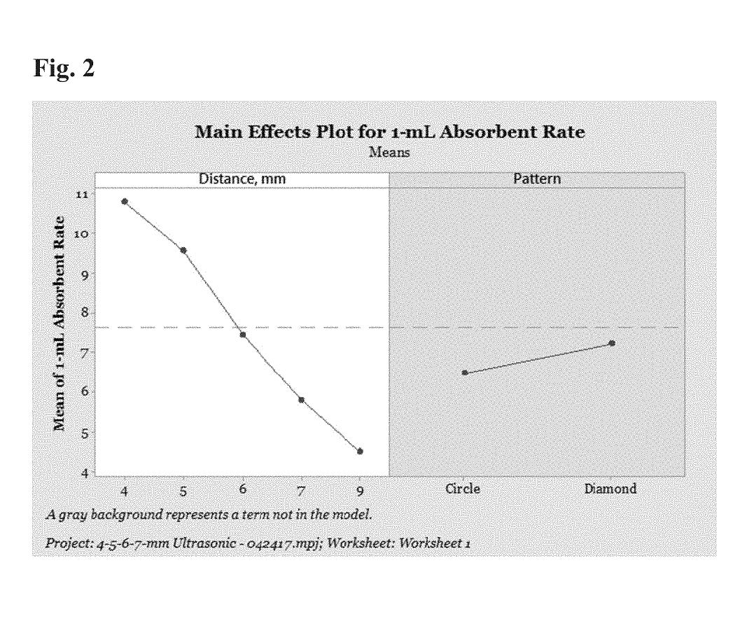

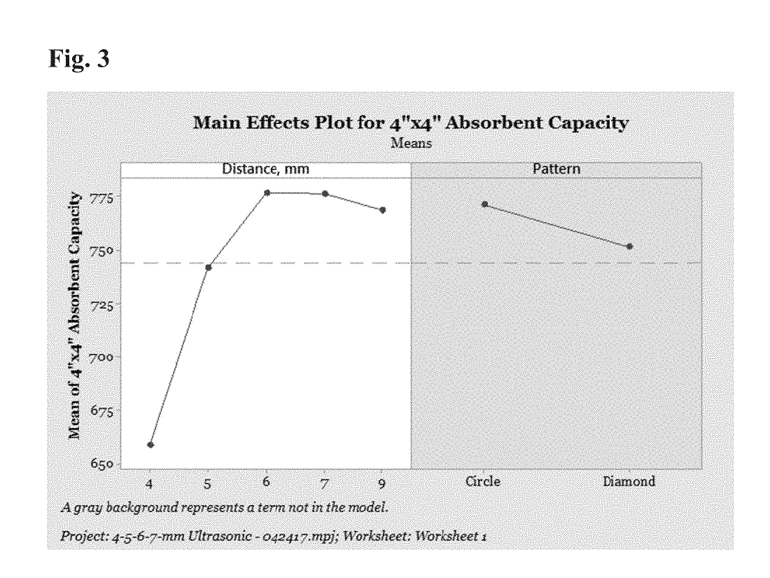

The inventors of the present invention surprising discovered that a multi-layered laminate with a bond pattern of the present invention can have the counter-intuitive effect of increasing absorption rate and/or decreasing percent run-off as the as distance between bond points is increased and/or the number of bond points per area decreases (see FIGS. 2 and 3). It is logical that less-rutted/smoother surfaces (like those with fewer bond points/area) would tend to absorb fluids at a lower rate (resulting in increased percent run-off) with fewer bond-point penetrations and lower surface area. In contrast, the inventors of the present invention discovered the opposite effect as shown in FIGS. 2 and 3.

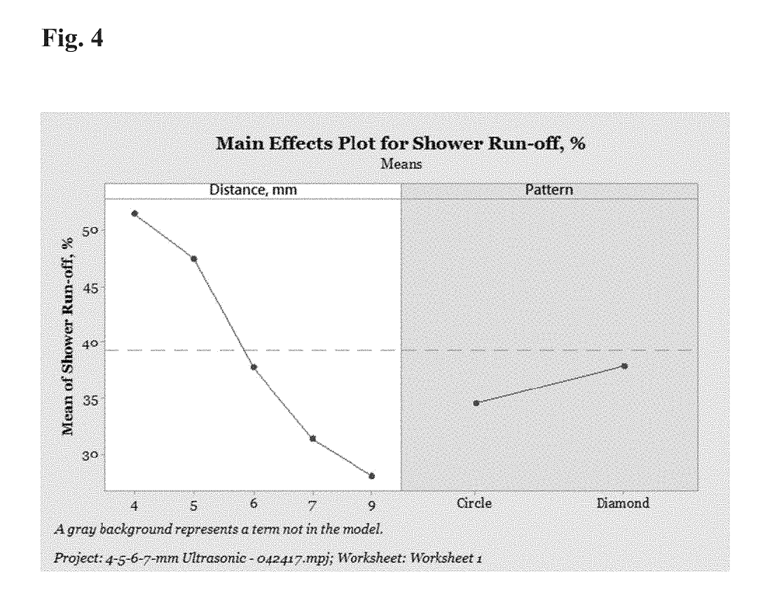

Additionally, the absorption capacity (see FIG. 4) reaches a maximum at 6 mm pin distance, which would discourage one skilled in the art to consider extending further the pin distance to achieve better absorption properties. Prior to the discovery of the present invention, one would have thought that absorption rate would be related proportionally to absorption capacity and that percent run-off would be related inversely to absorption capacity. For these reasons, the considerations of pin distances at a greater distance than 6 mm would be unlikely by one skilled in the art.

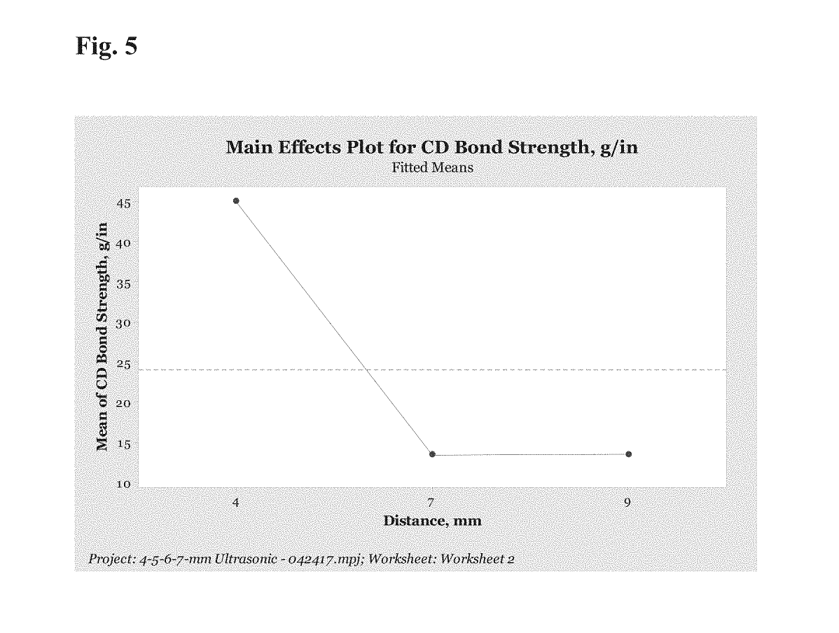

Another aspect of increased pin distance that would discourage consideration by an inventor is the reduction in lamination bond strength. As can be seen in FIG. 5, the present inventors discovered that lamination bond strength (at constant bond area per pin) decreases with increased pin distance. This is driven by the lower total bond area as the number of bond pins/area decreases. FIG. 5 also shows that the relative bond strength of both 7 mm pin distance and 9 mm pin distance provide suitable lamination bond strength for many applications. It is noted also that the area per bond pin (increased from the 1 mm used in these graphs) can increase bond area and can be used address most issues with low lamination bond strength.

In some embodiments, a multi-layered laminate of the present invention may have a bond strength of about 5 grams per inch or more, such as, for example, a bond strength of about 8 grams/inch to about 100 grams/inch. The bond strength may be measured between adjacent layers of the laminate and/or may be measured in accordance with AATCC 136. In some embodiments, bond strength may be measured in the machine direction (MD) and/or cross machine direction (XD). In some embodiments, the multi-layered laminate may have a laminated bond strength in the machine direction (MD) and/or cross direction (XD) in a range of about 5 grams/inch to about 200 grams/inch (e.g., about 5, 10, 15, 20, 30, 40, 50, 60, 70, 80, 90, 100, 125, 150, 175, or 200 grams/inch) as determined in accordance with AATCC 136.

In some embodiments, a multi-layered laminate of the present invention may have an absorbent capacity of about 400% to about 1,500%, optionally when measured with a 4 inch by 4 inch sample and/or a 5 gram sample of the multi-layered laminate and/or when measured in accordance with test method NWSP 10.1 entitled “Three Standard Test Methods for Nonwoven Absorption” with a 5 gram sample of the multi-layered laminate. In some embodiments, absorbent capacity is measured, optionally at standard atmosphere (20° C. and 65% room humidity), by first weighing a 4×4 inch sample, then placing the sample into a container of water (e.g., deionized water) for about 1 minute. The sample is taken out of the water and allowed to drain for about 2 minutes. Then, the sample is re-weighed and the percent absorbency capacity is calculated as follows: percent absorbent capacity=((wet weight−dry weigh)/dry weight)×100.

In some embodiments, a multi-layered laminate of the present invention may absorb 1 mL of water in about 1, 2, 3, 4, 5, 6, or 7 seconds and may optionally be in the range of about 1.5 seconds to about 5 or 6 seconds. Water absorbance may be measured, optionally at standard atmosphere (20° C. and 65% room humidity), with a 8 inch×8 inch sample that is placed flat on a surface, and 1 mL of water (e.g., deionized water) is dispensed (e.g., in less than about 4 seconds) onto approximately the center of the sample. The test is completed when the reflection of light off the surface of the water can no longer be seen. A timer may be started when the water is first applied onto the sample (e.g., when the water first leaves the pipette). The timer is stopped when all the water is absorbed into the sample and the reflection of light off the surface is no longer visible.

In some embodiments, a multi-layered laminate of the present invention may have a percent run-off of about 0%, 10%, 20%, 30%, 40%, or 50%, and may optionally be in the range of about 0% or 5% to about 30%, 40%, or 50%. Percent run-off may be measured in accordance with test method ISO 9073-11 entitled “Textiles—Test methods for nonwovens—Part 11: Run-off”. In some embodiments, percent run-off may be measured, optionally at standard atmosphere (20° C. and 65% room humidity), by taking a sample that is 5 inches wide by 18 inches long and placing the sample upon a surface (e.g. the surface of a plate) at a 45 degree angle (absorbent side up) and attaching (e.g., clamping) the sample to the top edge of the surface. Water (e.g., distilled and/or deionized water) in the amount of 25.0 grams is poured into a funnel with a shower head attachment at the opposite end (similar to AATCC 42 entitled “Water Resistance: Impact Penetration Test”). Then the amount of fluid that is repelled (i.e., runs off) the fabric is calculated by the following: percent run-off=((25−wet sample weight)/25) grams×100%.

A multi-layered laminate of the present invention may be prepared used thermal bonding, ultrasonic bonding, and/or adhesive bonding. In some embodiments, a multi-layered laminate of the present invention may be prepared using ultrasonic bonding. In some embodiments, a laminated article of the present invention may be prepared using adhesive bonding. In some embodiments, multi-layered laminate may be prepared using thermal bonding. In some embodiments, a laminated article of the present invention may be prepared using adhesive bonding and thermal or ultrasonic bonding. Thus, in some embodiments, two or more different laminating steps may be performed and/or carried out.

A method of the present invention may comprise ultrasonically bonding two or more layers (e.g., a first and second nonwoven fabric and/or a nonwoven fabric and a barrier material) using appropriate settings of amplitude, pressure, and line speed (i.e., dwell time) on the laminator, and optionally a bond pattern (e.g., a bond pattern from about 1% to 20% impression area, in some embodiments about 13% impression area). In some embodiments, a Branson 900 laboratory ultrasonic bonding unit set at about 15 to about 40 psi pressure on the horn, a line speed of about 0.1 to about 2 feet per second and about 70 to about 95% amplitude can create a laminate with appropriate bond strength and/or barrier properties.

In some embodiments, the laminating step may include thermally laminating a barrier material to a fabric with appropriate settings of temperature, pressure, line speeds (i.e. dwell time) and optionally a bond pattern (e.g., a bond pattern from about 1% to 20% impression area, in some embodiments about 13% impression area). In some embodiments, conditions used on the thermal-bonding laminator may be about 200 F to about 450 F on anvil and pattern bonding rolls temperatures, a pressure range of about 100 to about 800 pounds per linear inch (ph) between the bonding rolls and line speed of about 50 to about 1000 feet per minute.

The laminating step may include adhesively laminating two nonwoven fabrics and/or a barrier material to a nonwoven fabric. The process of joining two layers with an adhesive is referred to herein as “adhesive lamination”. The term “adhesive” as used herein refers to any binder and/or chemical substance that can hold two layers together and/or cause them to stick together with a measurable force. For example, an adhesive may bond a film to another film that may comprise the same or a different material. Alternatively or in addition, an adhesive may bond a film to a fabric.

Any suitable adhesive may be used, such as, for example, a flame resistant adhesive material, water-based adhesive, solvent-based adhesive, hot melt adhesive, powder adhesive, web adhesive, and/or film adhesive. In some embodiments, the adhesive may be an aqueous, solvent, hot melt, thermoplastic or thermoset adhesive. Example adhesives that may be used include, but are not limited to, pressure sensitives, polyesters, acrylates, acetates, polyamides, ethylene vinyl acetates (EVAs), ethyl methacrylates (EMAs), polyolefins, thermoplastic polyurethanes, and/or reactive moisture cure urethanes. In some embodiments, the adhesive provides greater than 10 grams/inch of bond strength between the contiguous layers when tested in accordance with AATCC 136.

Some embodiments include that when an adhesive is applied to a surface an adhesive layer may be applied and/or formed. The adhesive layer may be substantially continuous or may be discontinuous and may cover at least about 5% and up to 100% of the surface as measured using microscopic examination of the coated surface. In some embodiments, an adhesive layer may be provided on a surface and the adhesive layer may cover at least about 5%, 10%, 20%, 30%, 40%, 50%, 60%, 70%, 80%, 90%, 95% or more of the surface. One or more layers of an adhesive (e.g., 1, 2, 3, 4, 5, or more) may be applied to a surface, which may provide one or more adhesive layers (e.g., 1, 2, 3, 4, 5, or more).

An adhesive may be applied to a surface using methods known to those of skill in the art. For example, an adhesive may be applied using gravure printing (e.g., aqueous or solvent base media), screen printing, knife over roll coating, spraying, transfer printing, adhesive web, gravure printing hot melt adhesive (e.g., thermoplastic polymer base pressure sensitive adhesive (PSA) or reactive thermoset base, e.g., moisture cure urethane), porous coat hot melt adhesive (e.g., thermoplastic polymer base PSA or reactive thermoset base, e.g., moisture cure urethane), slot coating (thermoplastic polymer base PSA or reactive thermoset base, e.g., moisture cure urethane), and/or powder sprinkling (via Schindler roll).

A multi-layered laminate of the present invention may be used for any purpose. In some embodiments, the laminate may be suitable and/or used in medical applications.

The invention will now be described with reference to the following examples. It should be appreciated that these examples are not intended to limit the scope of the claims to the invention, but are rather intended to be exemplary of certain embodiments. Any variations in the exemplified methods that occur to the skilled artisan are intended to fall within the scope of the invention.

### EXAMPLES

### Example 1

FIGS. 2-5 show the testing results for nonwoven laminates having the following structure:

Impermeable thermoplastic film as base,

Multiple layers of hydrophilic nonwovens (PP, wood pulp, rayon, etc.), and

Spun bond polypropylene face.

These layers were laminated using ultrasonic or thermal bonding techniques with bonding patterns specified. The bond points were 1 mm² in area and were either circular or diamond. These bond-points were spaced apart on the bond roll/plate by the mm distance specified on the x-axis of the graphs.

Tested was conducted using traditional non-woven quality control laboratories in a controlled environment.

FIGS. 2-5 demonstrate an improvement in absorption performance improvement compared to a typical bond pattern geometry. Laminates were: (1) 2 layers of 30 gsm hydrophilic polypropylene spunbond, (2) 3 layers of 20 gsm hydrophilic polypropylene spunbond, or (3) 4 layers of 15-gsm hydrophilic polypropylene spunbond, which were ultrasonically bonded to a 0.6 mil polypropylene (PP) film.

### Example 2

Example multi-layered laminates of the present invention are described below in Table 1.

TABLE 1
Example multi-layered laminates.

| | | | | | 1-mL | | | |
|---|---|---|---|---|---|---|---|---|
| | | | Basis | | Absorbency | 4“x4” Absorbent | | Shower |
| | | | Weight | Thickness | Rate | Capacity | | Run-off |
| Top Layer | Core Layer | Barrier Layer | (gsm) | (microns) | (s) | % | gsm | % Repelled |
| 22-gsm hydrophilic | 35-gsm hydrophobic | 14.9-gsm | 75.0 | 653.8 | 5.5 | 455 | 341 | 41.0 |
| polypropylene | hydro entangled | Polypropylene | | | | | | |
| spunbond | polypropylene | film | | | | | | |
| | spunbond | | | | | | | |
| 22-gsm hydrophilic | 35-gsm wood | 14.9-gsm | 72.0 | 754.5 | 2.8 | 525 | 378 | 23.0 |
| polypropylene | pulp/polypropylene | Polypropylene | | | | | | |
| spunbond | spunbond spunlace | film | | | | | | |
| 22-gsm hydrophilic | 45-gsm wood | 14.9-gsm | 79.5 | 747.5 | 3.0 | 600 | 475 | 21.5 |
| polypropylene | pulp/polypropylene | Polypropylene | | | | | | |
| spunbond | spunbond spunlace | film | | | | | | |
| 22-gsm hydrophilic | 60-gsm wood | 14.9-gsm | 99.8 | 870.5 | 3.5 | 516 | 515 | 15.0 |
| polypropylene | pulp/polypropylene | Polypropylene | | | | | | |
| spunbond | spunbond/carded rayon | film | | | | | | |
| | spunlace | | | | | | | |
| 22-gsm hydrophilic | 71-gsm | 14.9-gsm | 113.5 | 1795.0 | 2.0 | 846 | 960 | 0.0 |
| polypropylene | polyester/polypropylene | Polypropylene | | | | | | |
| spunbond | bico Through-Air Bond | film | | | | | | |
| 22-gsm hydrophilic | 70-gsm polyester 70% | 14.9-gsm | 106.5 | 1423.0 | 2.1 | 809 | 862 | 0.0 |
| polypropylene | Bico PP/PET + 30% | Polypropylene | | | | | | |
| spunbond | PET Through-Air Bond | film | | | | | | |
| 34-gsm hydrophilic | 2 layers of 25-gsm | 14.9-gsm | 97.7 | 813.5 | 3.8 | 418 | 408 | 25.1 |
| polypropylene | hydrophilic | Polypropylene | | | | | | |
| spunbond | polypropylene | film | | | | | | |
| | meltblown | | | | | | | |
| 22-gsm hydrophilic | 2 layers of 22-gsm | 25.1-gsm | 80.1 | 756.2 | 2.9 | 504 | 403 | 23.5 |
| polypropylene | hydrophilic | Polypropylene | | | | | | |
| spunbond | polypropylene | film | | | | | | |
| | spunbond | | | | | | | |
| 20-gsm hydrophilic | 20-gsm hydrophilic | none | 60.5 | 541.1 | 2.9 | 504 | 305 | 22.9 |
| polypropylene | polypropylene | | | | | | | |
| spunbond | spunbond | | | | | | | |

The foregoing is illustrative of the present invention, and is not to be construed as limiting thereof. The invention is defined by the following claims, with equivalents of the claims to be included therein. All publications, patent applications, patents, patent publications, and other references cited herein are incorporated by reference in their entireties for the teachings relevant to the sentence and/or paragraph in which the reference is presented.

That which is claimed is:

1. A multi-layered laminate comprising:
a first nonwoven fabric; and
a second nonwoven fabric;
wherein the second nonwoven fabric is bonded to the first nonwoven fabric with a bond pattern including a plurality of bond points with each bond point in the plurality having an area of about 0.5 mm² to about 2.5 mm² and at least a portion of the bond points in the plurality are separated from an immediately adjacent bond point by 6 mm to about 25 mm.

2. The multi-layered laminate of claim 1, further comprising a barrier material, wherein the second nonwoven fabric is between the first nonwoven fabric and the barrier material.

3. The multi-layered laminate of claim 2, wherein the barrier material and the second nonwoven fabric are thermally or ultrasonically bonded together.

4. The multi-layered laminate of claim 1, wherein first nonwoven fabric and the second nonwoven fabric are thermally or ultrasonically bonded together.

5. The multi-layered laminate of claim 1, wherein all of the bond points in the plurality are separated from each other by 6 mm to about 15 mm.

6. The multi-layered laminate of claim 1, wherein the bond points have a shape that is circular or diamond shaped.

7. The multi-layered laminate of claim 1, wherein the bond points have a diameter of about 1 mm.

8. The multi-layered laminate of claim 1, wherein the multi-layered laminate has a bonded area of about 1% to about 20%.

9. The multi-layered laminate of claim 1, wherein the bond points have a pin height of about 0.5 mm to about 2 mm.

10. The multi-layered laminate of claim 1, wherein the first nonwoven fabric and/or the second nonwoven fabric comprise thermoplastic fibers.

11. The multi-layered laminate of claim 1, wherein the first nonwoven fabric and/or the second nonwoven fabric comprise one or more layer(s).

12. The multi-layered laminate of claim 1, wherein the first nonwoven fabric comprises polypropylene fibers, polyethylene fibers, polylactic acid fibers, polyester fibers, wood pulp fibers, and/or blends and/or bicomponent fibers thereof.

13. The multi-layered laminate of claim 1, wherein the second nonwoven fabric comprises polypropylene fibers, polyethylene fibers, polylactic acid fibers, polyester fibers, wood pulp fibers, rayon fibers, and/or blends and/or bicomponent fibers thereof.

14. The multi-layered laminate of claim 2, wherein the barrier material is a thermoplastic film.

15. The multi-layered laminate of claim 1, wherein the multi-layered laminate has about 10 to about 20 bonds per inch².

16. The multi-layered laminate of claim 1, wherein the multi-layered laminate has a bond strength in the machine direction (MD) and cross direction (XD) in a range of about 5 or 8 grams/inch to about 100 or 200 grams/inch as measured in accordance with AATCC 136 test method.

17. The multi-layered laminate of claim 1, wherein the multi-layered laminate has an absorbent capacity of about 400% to about 1,000% or 1,500% when measured with a 4 inch by 4 inch sample of the multi-layered laminate.

18. The multi-layered laminate of claim 1, wherein the first nonwoven fabric and/or the second nonwoven fabric is devoid of hydrophilic materials.

19. A method of manufacturing a multi-layered laminate, the method comprising:
thermally or ultrasonically laminating together a first nonwoven fabric and a second nonwoven fabric and/or a barrier material and the second nonwoven fabric to provide a plurality of bond points,
wherein bond points in the plurality of bond points have an area of about 0.5 mm² to about 2.5 mm² and at least a portion of the bond points in the plurality of bond points are separated from each other by 6 mm to about 25 mm.

20. The method of claim 19, wherein the multi-layered laminate is ultrasonically laminated with an attenuation in a range of about 80% to about 90%, a pressure of about 20 psi to about 30 psi, and/or a speed of about 0.5 fpm to about 2 fpm.
